(19) United States
(12) Patent Application Publication
(10) Pub. No.: US 2008/0172604 A1
(43) Pub. Date: Jul. 17, 2008

(54) TIME REDUCTION MECHANISM IN SCHEMATIC DESIGN ENTRY PAGE SETUP

(75) Inventor: Saravanan Sethuraman, Tamil Nadu (IN)

Correspondence Address: SCULLY, SCOTT, MURPHY & PRESSER, P.C., 400 GARDEN CITY PLAZA, Suite 300, GARDEN CITY, NY, 11530, US

(73) Assignee: International Business Machines Corporation, Armonk, NY (US)

(21) Appl. No.: 11/617,602

(22) Filed: Dec. 28, 2006

(51) Int. Cl. G06F 17/00; G06F 17/50

(52) U.S. Cl. 715/243; 715/251; 703/1

(57) ABSTRACT

A method and system for schematic design entry page setup are provided. In one aspect, the method may comprise presenting a user interface for entering information associated with a page layout for designing hardware logic schematics, retrieving the entered information and creating a specified number of pages for schematic design entry to automatically include the entered information on the pages. A system in one aspect may comprise a script operable to execute on a machine to present a user interface for entering information associated with a page layout for designing hardware logic schematics, the script further operable to retrieve the entered information. The system may also include means for creating a specified number of pages for schematic design entry to automatically include the entered information on the pages. An option to change and/or update information upfront without having to navigate to individual pages may be provided.

### FIELD OF THE INVENTION

The present disclosure generally relates to schematic entry tools for aiding logic design in hardware, and particularly, to time reduction mechanism in schematic design entry page setup.

### BACKGROUND OF THE INVENTION

Logic design usually requires creating pages by the designer and configuring each page individually. In hardware schematic designs, creating a basic layout ready for the design entry is a time consuming process. Conventional schematic design entry tools require much manual work and time to generate the basic layout setup for logic designs, especially for those that involve complex logic designs. The existing tools do not have the option of creating bulk number of pages automatically with all the page information. Further, those existing tools do not have the utility or option to replace the page template in all the pages at once, requiring a designer to change the page template one by one.

Designers thus knowingly tend to spend much of their time on setting up the page layout for each and every page and for each project. After creating the pages with the page template manually, all the fields of the pages templates must also be manually filled and save individually or all at once. For instance, with the old methodology in schematic design entry, the page title for each page must be duplicated manually. Known tools provide the following structure to enter the page title: Click on Page Icon->Click on Button to write the Title->Move the Title to the correct field->Click to make sure that it is done->File->Save. This procedure takes about 1800 manual clicks for a 300-page schematic. In addition, to create 300 pages of schematics design entry, the existing schematic entry tools takes approximately 300 seconds and 300 manual clicks for page creation, 300 seconds and 600 manual clicks for pulling page template, 300 seconds and 300-600 manual clicks for saving the pages, 300 seconds and 300 manual clicks to fill the page template.

Accordingly, an improved system and method in schematic design entry tools is desirable for setting up entry pages. It is also desirable that such a design tool is user-friendly.

### SUMMARY OF THE INVENTION

A method and system for reducing time in schematic design entry page setup are provided. In one aspect, the method may comprise presenting a user interface for entering information associated with a page layout for designing hardware logic schematics, retrieving the entered information and creating a specified number of pages for schematic design entry to automatically include the entered information on the pages. A system in one aspect may comprise a script operable to execute on a machine to present a user interface for entering information associated with a page layout for designing hardware logic schematics, the script further operable to retrieve the entered information. The system may also include means for creating a specified number of pages for schematic design entry to automatically include the entered information on the pages.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating a method for a schematic design tool in one embodiment.

FIG. 2 is a flow diagram illustrating a method for setting up a basic layout for design schematic pages in one embodiment.

FIG. 3 is an example of a screen shot presented to a user for entering information for setting up design pages.

### DETAILED DESCRIPTION OF THE PREFERRED EMBODIMENTS

An exemplary embodiment of the present disclosure provides a tool for setting up a basic layout for a schematic design entry, including complex schematic design entries. In one embodiment a graphical user interface (GUI), for instance, implemented using scripts such as Tcl, Perl, tk or the like, provides a user-friendly tool for creating a basic layout. The GUI may be implemented using any other known or will be known techniques. In one embodiment, a user interface such as menu allows a user to enter information for setting up the pages. The user interface in one embodiment may be included as a part of a schematic design entry tool. Designer will be able use this menu to set up the basic layout for the complex schematic design entry, allowing the designer to cut the time spent on the basic setup and use that time for the actual design of the schematics.

The menu, in one embodiment, may contain options to enter project title, designer name (design owner), page template to be used, number of pages, page title, but not limited to such. After entering these and other details, the layout pages may be created, for example, using a script. The created pages will have the selected template and the specified fields filled in automatically. In one embodiment, this utility of the present disclosure may save all the pages automatically with the project “title_Sch_{—}1_page*.*”. The designer then may directly start entering the logic design into the tool, eliminating the need to create the page layout every time.

The setup tool of the present disclosure may also provide the flexibility of copying the pages within the project. For instance, if a designer or a user of the tool selects one or more pages to be copied from page “s” to page “d”, the tool copies the fill content of the page “s” to the destination page (page “d”). The tool may include an option to delete the pages. The delete option, for instance, may be used after completing the schematic to delete the unused pages. In one embodiment, the deleted pages may be stored, for example, in a project directory in a folder named, allowing the deleted pages to be retrieved easily.

In one embodiment, an icon for “Page setup” in the Project Manager Menu of a design tool window may be inserted. The icon allows a user to invoke the setup tool of the present disclosure. The icon can be implemented, for example, in *.bmp file. A GUI may be implemented as a script, for example, that prompts for and retrieves the fields as needed. GUI may contain “Update/Finish” button, List box and Blank entry fields for entering data, and optional “Check” boxes. When a user presses the “Update/Finish” button, the script may write the entered or populated field data to a *.txt file. A program or a module executes to create a page, using the data from the text file (*.txt file containing the entered data), pulling the page template from a library of templates, and updating the different fields in the pages created from the template. The program may repeat the executing for the required number of pages specified, for example, by the designer. This program or module may a separate program from the script or part of the same script. After the page is set up, a notification informing the user that “N” number of pages created successfully may be presented, for example, on the GUI display. A user or designer can start entering the design directly from the created pages. At any time, a user may invoke the page setup GUI to enter or update the fields such as the page title, etc. Pressing “update/finish” button updates the page or pages with the newly entered data.

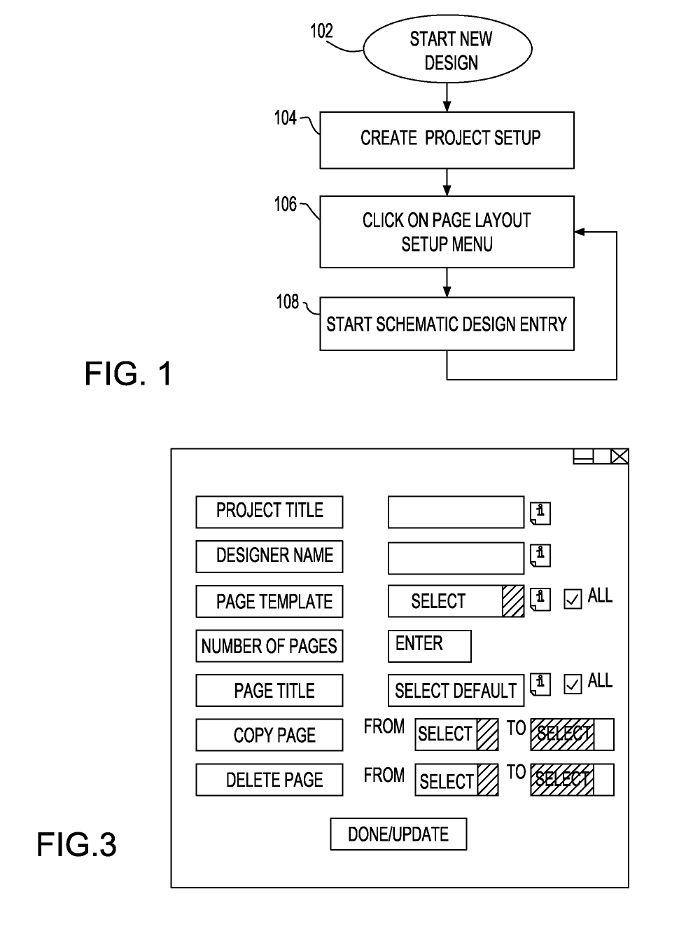

FIG. 1 is a flow diagram illustrating a method for a schematic design tool in one embodiment. At 102, a user, for example, a designer starts a new design. At 104, using a schematic design entry tool, a user sets up a project. At 106, a user uses a page layout setup tool of the present disclosure to setup a basic layout for the schematics pages. At 107, a user starts schematic design entry to design the desired layout.

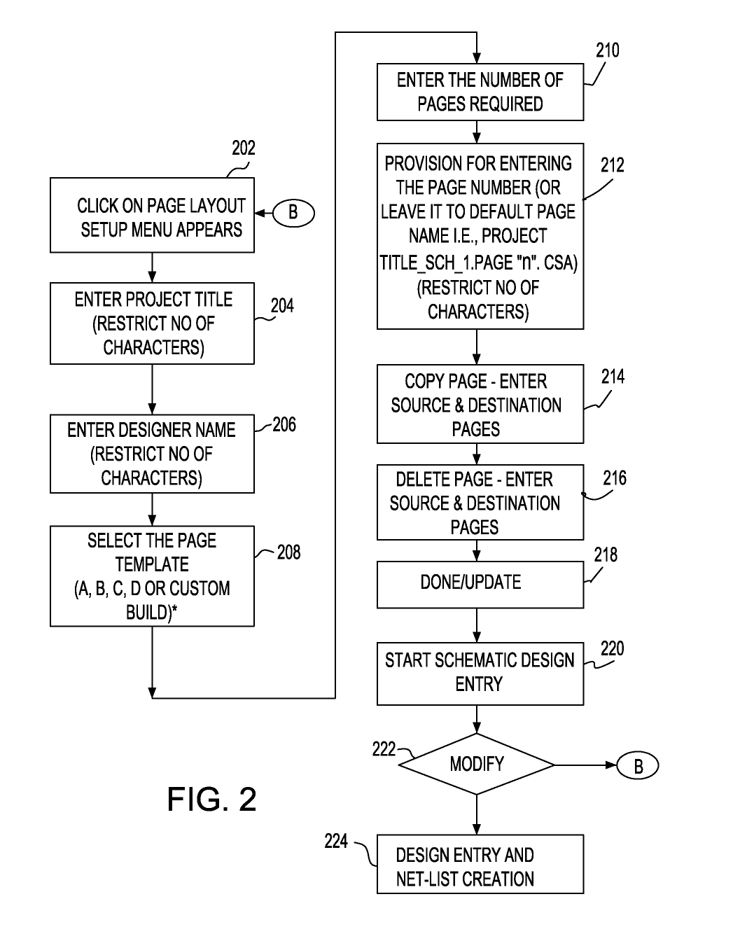

FIG. 2 is a flow diagram illustrating a method for setting up a basic layout for design schematic pages in one embodiment. At 202, a page layout setup menu is presented to a user, for instance, in response to step 106 of FIG. 1. At 204, a user may enter a project title. At 206, a user may enter designer name. At 208, a user selects a page template to use. A page template may be selected from a list of available templates presented to a user. A user may also specify a customized template to use, for example, by entering a file name and path. At 210, a user enters the number of pages. At 212, a user may enter a naming convention for the page numbers. At 214, a user may specify to copy pages. At 216, a user may specify to delete pages. At 218, a user presses “done/update” button. In response, a script retrieves the entered fields and a program creates the basic layout pages based on the entered data. At 220, a user may start schematic design entry using the created basic layout pages. At 222, if a user desires to modify any of the entries from the page layout setup menu, a user may invoke that menu at 202. At 224, design is created with the basic layout pages.

FIG. 3 is an example of a screen shot presented to a user for entering information for setting up design pages. A user optionally may enter a page title for all pages of the project. Alternatively, another menu may be presented so that a user may enter a different title for different pages. A default setting automatically may provide the page title with the project name_page*. A user may leave the page title blank and decide to enter the page title later, for instance, by using an update feature. The term “user” as used in this disclosure may include any user, human or non-human, for example, a machine or automated entity that executes the described steps.

The basic page layout setup tool of the present disclose allows a user to select a page template, enter fields, and press the Update button to automatically create and saves all the pages. With this tool, a user or designer need not open each page to enter the page title or to modify the page title. The setup tool disclosed in the present application can reduce designer time in setting up the layout and allow designer to concentrate on the intricacies of the design. While the tool works for both simple and complex designs, it is very effective in complex designs.

The page setup tool of the present disclosure may be implemented on a general-purpose computer or a specific-purpose computer. The embodiments described above are illustrative examples and it should not be construed that the present invention is limited to these particular embodiments. Thus, various changes and modifications may be effected by one skilled in the art without departing from the spirit or scope of the invention as defined in the appended claims.

I claim:

1. A method for schematic design entry page setup, comprising:
presenting a user interface for entering information associated with a page layout for designing hardware logic schematics;
retrieving the entered information; and
creating a specified number of pages for schematic design entry to automatically include the entered information on the pages.

2. The method of claim 1, wherein the step of creating includes creating a specified number of pages for schematic design entry using a specified page template and automatically including the entered information on the pages.

3. The method of claim 2, further including:
replacing the specified number of pages with a different template and associated attributes at once.

4. The method of claim 1, wherein the user interface includes a graphical user interface.

5. The method of claim 1, wherein the information associated with a page layout include project title, designer name, design owner, page template to be used, number of pages, page title, or combinations thereof.

6. The method of claim 1, wherein the steps of presenting, retrieving and creating are carried out as part of a schematic entry design tool.

7. A system for schematic design entry page setup, comprising:
a script operable to execute on a machine to present a user interface for entering information associated with a page layout for designing hardware logic schematics, the script further operable to retrieve the entered information; and
means for creating a specified number of pages for schematic design entry to automatically include the entered information on the pages, the means for creating further operable to update the pages with additional or new information.
